(19) United States
(12) Patent Application Publication
(10) Pub. No.: US 2005/0050869 A1
(43) Pub. Date: Mar. 10, 2005

(54) Heat stable filter construction

(76) Inventor: Robert Haes, Braunschweig (DE)

Correspondence Address: BARLOW, JOSEPHS & HOLMES, LTD., 101 DYER STREET, 5TH FLOOR, PROVIDENCE, RI, 02903, US

(21) Appl. No.: 10/487,001

(22) PCT Filed: Aug. 8, 2002
(86) PCT No.: PCT/GB02/03645

(30) Foreign Application Priority Data
Aug. 17, 2001 (GB) 0120094.8

(51) Int. Cl. B01D 46/00

(52) U.S. Cl. 55/497

(57) ABSTRACT

A filter construction includes a pair of pleated filter elements (31, 32) mounted back to back to form a fluted double filter element and having their edges sealed by a sealant or being folded over within U-sectioned resistant edge strips The filter elements comprise a foraminous metal member (12) embedded within or faced on each side with a layer of non-women material (10), which is hydro entangled through the apertures of the metal member (12) and may include stainless steel fibres and the surface laminated or coated with a fluoropolymer.

This invention relates to a heat stable filter construction.

A known type of filter construction includes a filter element which is made from two pleated sheets of a filter medium, with pleated edges of the sheets held by top and bottom frame members. The sheets are usually disposed so that ridges of adjacent folds contact, forming lozenge-sectioned enclosures. Structural stability is achieved by using adhesive to join the contacting fold ridges, and to seal the edges of the pleated sheets to the frame members and to each other. The filter medium may also be heat or chemically treated.

An example of such a filter construction is shown in EP-A-0, 351, 850, which has the innovative feature that the contacting pleats of the two filter sheets are overlapped to provide for improved adhesion between them.

Such filter constructions which are secured by use of adhesives are only suitable for use at temperatures up to eg. 80° C., at the most 120° C., depending upon the composition used. The adhesives and chemical treatments are also subject to attack in arduous chemical environments. However whether the adhesive or chemical treatment is degraded by thermal or chemical attacks, used at high temperatures ie. over 80° C. or in arduous chemical environments (whether reducing or oxidising, acid or alkaline) the degradation of the adhesive or chemical treatment compromises the structural stability of the filter. For example, joint failure may cause ballooning of the filter medium. Chemical attack also compromises the chemical stability of the filter medium itself or its chemically treated surface, which may as a result become chemically reactive or catalyse an unwanted reaction or have its wetting properties adversely effected.

An object of the invention is to provide a filter construction which is structurally stable at high temperatures, e.g. in excess of 80° C. to enable the filter to be useable in high temperature conditions. This may be achieved by providing a filter construction in which adhesives and chemical treatments are not used to secure the filter medium into the filter construction and it is a further object of the invention to provide such an adhesive free filter construction.

According to the invention, a filter construction comprises a filter medium which comprises a composite structure of a foraminous metal reinforcement and a non-woven fibrous material on one or both faces of the metal reinforcement, characterized in that the non-woven fibrous material is consolidated by hydro-entanglement after assembly with the metal reinforcement, the hydro entanglement jets passing through the apertures of the foraminous metal reinforced.

Unless the apertures of the foraminous metal are precisely aligned with the needles of a needling apparatus, it is not possible to consolidate the felt by needling. A felt which has been already consolidated by needling may however be assembled with the metal reinforcement.

The metal reinforcement may comprise a sheet of metal formed with a multitude of appropriately dimensioned and spaced apertures, or a fine or ultra-fine wire mesh with an appropriately selected mesh size. A sheet with micro-scale apertures may be formed by etching a sheet or foil through a mask. The fibrous material may be laminated with an e.g. perforated or porous membrane or coated with a polymer coating, wherein the membrane or coating is also resistant to arduous chemical or temperature conditions. Suitable materials may be PTFE membrane, or a fluoro polymer foam.

The fibrous material is preferably a non-woven fabric of high temperature resistant fibre such as PTFE, PPS or polyimide.

The filter element may comprise two pleated sheets of the filter medium disposed back to back to form a fluted double filter element enclosing lozenge shaped volumes, and the edges of the pleated sheets may be joined by non-adhesive using means such as the use of welding of the metal reinforcements, or by folding over the overlapping edges of the pleated sheets through at least one fold, preferably two or more folds. The folded overlapped edges may be further secured by u- or trough sectioned, preferably resilient, metal side strips.

The use of a high temperature sealant, such as a silicone material in place of welding for the overlapping edges of the pleated sheets, is possible.

If it should be necessary eg. with high pressures to reinforce the pleated sheets of the filter medium, to prevent “ballooning”, inserts may be placed within the reentrant valleys of the pleats, in the form for example circular rods, V or U sectioned strips. Alternatively, the outward facing ridges of the pleats may be capped with V-sectioned strips, or a belt or ribbon passed about the outside of the filter element, and a reinforcement extended between the pleated sheets of filter medium.

Some examples of filter construction according to the invention will now be described by way of example, with reference to the accompanying drawings wherein:—

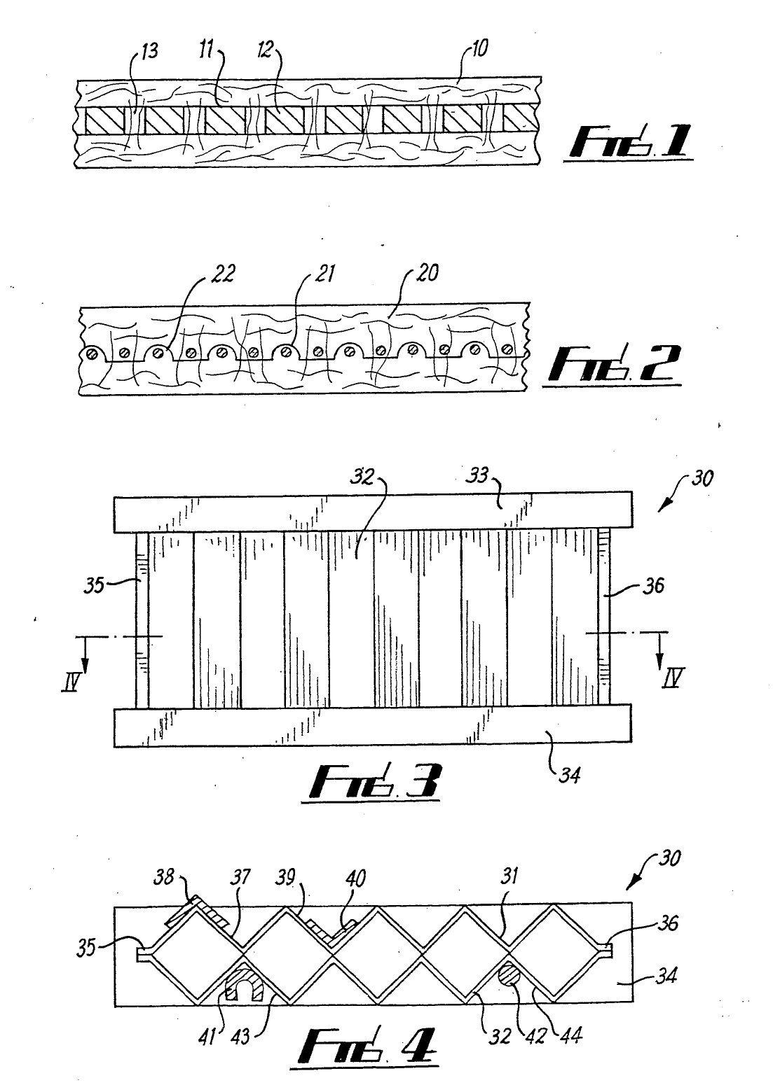

FIG. 1. is a sectional view of a part of a filter medium forming part of the invention;

FIG. 2. is a sectional view of a part of a second filter medium forming part of the invention;

FIG. 3. is an elevation of a compact filter element in accordance with the invention;

FIG. 4. is a sectional view on line IV-IV of FIG. 3. and shows some alternative means for supporting the filter medium against “ballooning”;

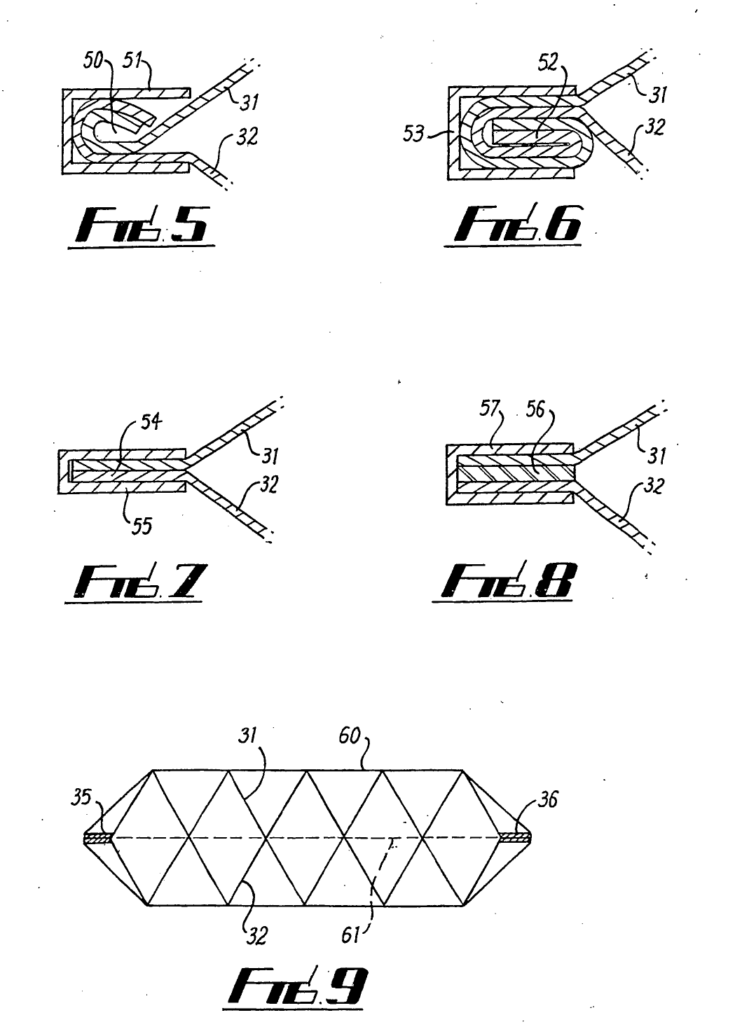

FIG. 5. is a detailed sectional view of a first a form of edge seal;

FIG. 6. is a detail sectional view of a second form of edge seal;

FIG. 7. is a detail sectional view of a third form of edge seal, using welding;

FIG. 8. is a detailed sectional view of a fourth form of edge seal, using a high temperature sealant; and

FIG. 9. is a view similar to FIG. 4. showing further means for supporting the filter medium sheets.

FIG. 1. shows a cross section of a first embodiment of filter medium for use in a filter construction according to the invention. The filter medium comprises a two layer composite and consists of a layer of a non-woven fibrous material 10 on either side of metallic support 11 in the form of a foraminous perforated sheet 12. The fibrous material 10 is consolidated by hydro entanglement in place upon the metallic support 11, so that the entanglement is achieved through the apertures 13 of the sheet 12, so that the fibrous material forms a single integrally linked structure incorporating the support 11, instead of being a pair of minimally connected batt layers on either side of the support 11. This avoids the use of adhesive bonding to bind such separate layers to the support which would be likely to fail at high temperatures causing the fibrous material to be shed from the support 11.

The fibrous material 10 is consolidated by hydro entanglement rather than needling, as it is done in place on the metallic support and unless the needles of a needling machine were accurately spaced and aligned with the apertures of support 11 needling is not possible to carry out. The provision of such accurate spacing and alignment whilst not impossible would be a time consuming and costly task.

A second embodiment of filter medium is shown in cross section in FIG. 2., and this again comprises a layer of a nonwoven fibrous material 20 on either side of a metallic support 21 in the form of a woven wire mesh 22. Again, the fibrous material 20 is consolidated by hydro entanglement in place upon the mesh support 21 so that the entanglement is carried through the apertures of the mesh 22 so that the fibrous material 20 forms a single integrally linked structure incorporating the mesh 22 instead of being merely a pair of minimally connected batt layers on either side of the support 21.

Filter media such as shown on FIGS. 1. and 2. can be, in accordance with the invention, used in the construction of compact filtration elements, such as shown in FIGS. 3, 4. and 9.

In FIGS. 3. and 4. a compact filtration element 30 comprises a pair of pleated filter medium sheets 31, 32 which are held above and below by frame members 33, 34. The sheets 31, 32 are arranged so that in the usual manner, lozenge shape cross sectioned volumes are enclosed within the pleats, separated by the reentrant folds of the filter sheets 31, 32. The sheets 31, 32 have edge regions 35, 36 which are overlapped to enable provision of an adhesive free edge seal as shown in more detail in FIGS. 5. to 8.

In order to prevent “ballooning” of the filter sheets 31, 32 under the effect of an excessive pressure differential between the internal and external volumes of the filter, the filter sheets may be supported by profiled strips disposed on the outside (low pressure) sides of the pleats, for example each outward pleat ridge such as 37 may be equipped with a V-sectioned sectioned support strip 38, or each inward pleat valley such as 39 would be similarly equipped with a V-sectioned support strip 40 The strips 38 and 39 may be identical and simply differ by their location.

Alternative support members include U-shaped strips 41, or circular cross sectioned rods 42, received in respective inward pleat valleys 43 and 44.

As these particularly, the V-shaped strips 38 and 40 cause some occlusion, or “blinding” of substantial areas of the filter medium sheets, it is preferred to avoid their use unless essential to support the filter medium. An alternative might be to select a filter medium having a more robust built in metal support.

Alternative edge seals for the junction of the edges of the filter medium sheets 31, 32 are shown in FIGS. 5. to 8. In FIG. 5. the edges of the sheets 31, 32 are simply overlapped and then folded over once in a single fold 50, and the fold then secured with a resilient channel sectioned strip 51.

It is envisaged that the strip 51 may be omitted unless found to be essential.

In FIG. 6. the sheets 31, 32 are again overlapped, but this time folded twice to form a substantially rolled up edge 52, which is secured by a resilient channel sectioned strip 53. As in FIG. 5. the strip 53 may be omitted if not found to be essential.

In FIG. 7. the sheets 31, 32 are overlapped, and the edge regions are secured by welding, so as to bond the metal support components of the sheets together in a weld zone 54. Again a resilient edge strip 55 may optionally be provided.

In FIG. 8. the difference from FIG. 7 is that instead of welding, the sheet edge regions are secured by a high temperature resistant silicone sealing compound 56, together again with an optional resilient edge strip 57.

Further each of the edge seals described above may be further secured by “potting” with a silicone high temperature sealing compound.

FIG. 9. shows in a sectional view similar to FIG. 4, a band 60 in the form of a thin metal strip which is passed around the exterior of the filter element, and a central support member 61, between the pleated filter member sheets 31, 32. More than one such band may be provided if necessary. The support member 61 is a perforated metal sheet or a plurality of metal strips secured between the pleated filter elements to prevent them from collapsing on top of each other.

The filter element described utilises no adhesive materials in its construction which might fail at temperatures from 80-120° C. and is thus capable of being used at much higher temperatures than adhesive bonded filters and is thus suitable for high temperature applications, such as cleaning combustion exhaust gases, and in chemical processes.

1. A filter construction comprising a filter medium, the filter medium comprising a composite structure of a foraminous metal reinforcement having opposing side faces and a consolidated non-woven fibrous material on one or more faces of the metal reinforcement, wherein the fibrous material is consolidated by hydro entanglement jets, the jets passing through apertures of the foraminous metal reinforcement.

2. (Canceled)

3. A filter construction according to claim 1, wherein the metal reinforcement comprises a sheet of metal formed with a multitude of apertures.

4. A filter construction according to claim 1, wherein the metal reinforcement comprises a fine or ultra-fine wire mesh.

5. A filter construction according to claim 1, wherein the non-woven fibrous material includes metal fibres blended with polymer fibres or with a blend of polymer fibres.

6. A filter construction according to claim 1, wherein the non-woven fibrous material comprises high temperature resistant fibres with a porous fluoropolymer coating.

7. A filter construction according to claim 6, wherein the porous fluoropolymer coating contains carbon powder.

8. A filter construction according to claim 1, wherein the filter medium is formed as two pleated sheets which are disposed back to back to form a fluted double filter element, the edges of the pleated sheets being joined by non-adhesive means.

9. A filter construction according to claim 8 wherein the edges of the pleated sheets are joined by folding over overlapping edges of the sheets, and secured by U-sectioned resistant metal side strips.

10. A filter construction according to claim 8 wherein inserts are placed in the re entrant pleats of the sheets, or over the outward ridges thereof to reinforce the filter medium sheets.

11. A filter construction according to claim 8, wherein the overlapping edges of the pleated sheets are secured by a high temperature sealant.
